(19) United States
(12) Patent Application Publication
(10) Pub. No.: US 2004/0240430 A1
(43) Pub. Date: Dec. 2, 2004

(54) IP gateway for hybrid circuit switched and IP based mobile wireless telephone system

(75) Inventors: Nan-Sheng Lin, Fremont, CA (US); Chih-Ping Lee, Cupertino, CA (US); Shih-An Cheng, Milpitas, CA (US); Paylun Ju, Cupertino, CA (US)

Correspondence Address: TIMOTHY P. O'HAGAN, 8710 KILKENNY CT, FORT MYERS, FL, 33912, US

(73) Assignee: Innomedia Pte Ltd., The Alpha (SG)

(21) Appl. No.: 10/445,998

(22) Filed: May 27, 2003

(51) Int. Cl. H04L 12/66

(52) U.S. Cl. 370/352

(57) ABSTRACT

An IP telephony gateway operates in conjunction with a base station of a hybrid micro cellular wireless telephone network. The base station supports roaming of a wireless telephone into a cell controlled by the base station. The IP telephony gateway comprises: i) a circuit switched network interface for exchanging system messaging, call signaling, and audio media with a circuit switched system controller; ii) a base station network interface for exchanging system messaging, call signaling, and audio media with a base station; and iii) a VoIP client for exchanging system messaging, call signaling and audio media with a remote VoIP device over a packet switched network. A management module interfaces messages exchanged with the base station and each of the circuit switched system controller and the soft switch to support roaming of the wireless telephone into the cell controlled by the base station.

### TECHNICAL FIELD

The present invention relates to a hybrid circuit switched and IP based microcellular wireless telephone system and more particularly to an IP gateway system that supports conversion of a circuit switched microcellular wireless telephone system into a hybrid circuit switched and IP based system.

### BACKGROUND OF THE INVENTION

For many years telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted-pair-copper-wire circuit. More specifically, each of the two endpoint telephones are coupled to respective local switching stations by a dedicated pair of copper wires known as a subscriber loop. The two switching stations are connected by a trunk line comprising multiple copper wire pairs. When a telephone call is placed, the circuit is completed by dynamically coupling each subscriber loop through its local switching station to a dedicated pair of copper wires in the trunk line that runs between the two local switching stations.

After the circuit is complete, call signaling, universally known as “ringing”, in the receiving telephone may commence. As will be discussed below, the signal causing the ringing may also convey certain information. Once the call is answered, the circuit is completed between the calling phone and the receiving phone.

Mobile wireless telephone technology has traditionally been coupled to the PSTN to enable calls between the PSTN and a wireless telephone. A wireless telephone system typically comprises a plurality of base stations, each of which provides wireless telephone service to those wireless telephone handsets within communication range of the base station. The communication range is typically referred to as a cell. The system includes a plurality of base stations to provide coverage over a larger geographical area. The base stations are coupled to one or more switching stations.

Each switching station is coupled to the PSTN and is assigned a block of telephone numbers-each of which is permanently assigned to a wireless telephone handset. The PSTN routes calls dialed to any of the telephone numbers within the block to the switching station. The switching station routes the inbound call to the appropriate base station that controls the cell in which the mobile telephone is located. The base station couples the call to the wireless telephone handset.

Calls initiated by the mobile telephone are first signaled to the base station and then routed by the base station to a switching station. The switching station routes the call to the PSTN which in turn routes the call to the subscriber loop associated with the number dialed on the handset.

More recently wireless voice communication systems have been developed that utilize smaller cells and a greater number of base stations. One such system is known as the Personal Handy-Phone System (PHS). The PHS utilizes a plurality of base stations and one or more PHS controllers. Each base station is coupled to a PHS controller by a dedicated (e.g. leased) ISDN line. The PHS controller is coupled to the PSTN.

An obvious advantage of the PHS over the large cell system is that infrastructure costs are much lower. For example, establishing a leased ISDN line between the PHS controller and the base station is significantly less expensive than laying a dedicated fiber trunk as would be required in the large cell system.

A disadvantage of the PHS is that the costs per call (particularly outgoing calls) can be significantly higher. The PHS generally supports a smaller number of calls than a large cell system and in particular, does not aggregate a large volume of calls through a single PSTN gateway to the PSTN as does the large cell system. PSTN service providers typically charge more on a “per call” basis for smaller call volumes than larger call volumes.

Therefore, there exists a need in the art for a wireless telephone system that provides the low infrastructure cost advantages of a micro-cellular wireless telephone system and the lower per call costs of a system wherein outgoing calls are aggregated to a single trunk to the PSTN.

### SUMMARY OF THE INVENTION

A first aspect of the present invention is to provide an IP telephony gateway for operation with a base station of a hybrid micro cellular wireless telephone network. The base station supports roaming of a wireless telephone into a cell controlled by the base station. The IP telephony gateway comprises: i) a circuit switched network interface (such as an ISDN controller chip set) for exchanging system messaging, call signaling, and audio media with a circuit switched system controller (such as a PHS system controller) over a circuit switched network (such as an ISDN leased line); ii) a base station network interface for exchanging system messaging, call signaling, and audio media with a base station over an ISDN connection; and iii) a VoIP client for exchanging system messaging, call signaling and audio media with a remote VoIP CPE device over a packet switched network.

The connection to the packet switched network may be over a physical medium implemented using any of a cable modem, a DSL modem, a traditional modem, an ISDN modem, a T1 interface circuit or other known systems of implementing a connection to an IP network.

A time slot switching unit interconnects and transfers audio media between the base station network interface and each of: i) the circuit switched network interface for supporting a media session with the circuit switched system controller; and ii) the VoIP client for supporting a VoIP media session over the packet switched network.

A management module exchanges messages with the base station, over the base station network interface, and with each of the circuit switched system controller and the soft switch to support roaming of the wireless telephone into the cell controlled by the base station.

The management module may comprise a roaming messaging module that provides for generating both: i) a first registration message to the circuit switched system controller, and ii) a second registration message to the soft switch, in response to receiving a single registration message initiated by the wireless telephone roaming into the cell controlled by the base station.

The roaming messaging module may further provide for generating both: i) a handover message to the circuit switched system controller, and ii) a registration message to the soft switch, in response to receiving a single handover message initiated by the wireless telephone roaming into the cell controlled by the base station (when the handover message includes a call identifier associated with a call routed through the circuit switched system controller).

The roaming messaging module may further provide for generating both: i) a handover message to the soft switch, and ii) a registration message to the circuit switched system controller, in response to receiving a single handover message initiated by the wireless telephone roaming into the cell controlled by the base station (when the handover message includes a call identifier associated with a call routed over the packet switched network).

The roaming messaging module may include a mapping table. The mapping table associates each message that the gateway may receive to a plurality of messages that the gateway produces in response thereto.

When the call identifier indicates an in process call is routed through the circuit switched system controller, the circuit switched system controller may provide a handover acknowledgement message to the management module. The handover acknowledgement message may include the call identifier. The management module may establish a circuit switched connection with the circuit switched system controller in response to receiving the handover acknowledgement from the circuit switched system controller.

When the call identifier indicates an in process call is routed over the packet switched network, the handover message to the soft switch may include identification of a gateway port configured for signaling a VoIP media session. The management module may then establish a VoIP channel with a remote VoIP CPE device in response to receiving a VoIP session set up request from the remote VoIP CPE device on the gateway port.

The management module may include a call identification module for determining which of a call support system selected from a group of call support systems consisting of the circuit switched system controller and the packet switched network is supporting an in process call associated with the call identifier. The call identification module may maintain an in process calls table that associates each call identifier with an indication of which of the circuit switched system controller and the packet switched network is supporting the in process call associated with the call identifier. Alternatively, the call identification module may couple to a remote in process calls server which associates each call identifier with an indication of which of the circuit switched system controller and the packet switched network is supporting the in process call associated with the call identifier.

A second aspect of the present invention is to provide a method of supporting roaming of a wireless telephone into a cell controlled by a base station in a hybrid micro cellular wireless telephone network. The hybrid micro cellular telephone network includes a gateway coupled to the base station. The gateway supports both circuit switched media sessions with a system controller and VoIP media sessions over a packet switched network. The method comprises generating both: i) a first registration message to the circuit switched system controller, and ii) a second registration message to a soft switch, in response to receiving a single registration message initiated by the wireless telephone roaming into the cell controlled by the base station.

The method may further comprise generating both: i) a handover message to the circuit switched system controller, and ii) a registration message to the soft switch, in response to receiving a single handover message initiated by the wireless telephone roaming into the cell controlled by the base station (when the handover message includes a call identifier associated with a call routed through the circuit switched system controller).

The method may further comprise generating both: i) a handover message to the soft switch, and ii) a registration message to the circuit switched system controller, in response to receiving a single handover message initiated by the wireless telephone roaming into the cell controlled by the base station (when the handover message includes a call identifier associated with a call routed over the packet switched network).

When the call identifier indicates an in process call is routed through the circuit switched system controller, the circuit switched system controller may provide a handover acknowledgement message to the management module. The handover acknowledgement message may include the call identifier. The method may comprise establishing a circuit switched connection with the circuit switched system controller in response to receiving the hand over acknowledgement from the circuit switched system controller.

When the call identifier indicates an in process call is routed over the packet switched network, the handover message to the soft switch may include identification of a gateway port configured for signaling a VoIP media session. The method may further include establishing a VoIP channel with a remote VoIP CPE device in response to receiving a VoIP session set up request from the remote VoIP CPE device on the gateway port.

The method may further yet comprise determining which of the circuit switched system controller and the packet switched network is supporting an in process call associated with the call identifier. Determining which of the circuit switched system controller and the packet switched network is supporting an in process call may include maintaining the in process calls table that associates each call identifier with an indication of which of the circuit switched system controller and the packet switched network is supporting an in process call associated with the call identifier.

Alternatively, determining which of the circuit switched system controller and the packet switched network is supporting an in process call may include: i) making an inquiry to a remote in process calls server; and ii) receiving a response from the remote in process calls server identifying which of the circuit switched system controller and the packet switched network is supporting an in process call associated with the call identifier.

For a better understanding of the present invention, together with other and further aspects thereof, reference is made to the following description, taken in conjunction with the accompanying drawings. The scope of the invention is set forth in the appended clams.

### BRIEF DESCRIPTION OF THE DRAWINGS

FIG. 1 is a block diagram representing a hybrid micro-cellular wireless telephone system in accordance with one embodiment of this invention;

FIG. 2 is a block diagram of a gateway in accordance with one embodiment of the present invention;

FIG. 3a is an exemplary digit map table in accordance with one embodiment of the present invention;

FIG. 3b is an exemplary registration table in accordance with one embodiment of the present invention;

FIG. 3c is an exemplary open calls table in accordance with one embodiment of the present invention;

FIG. 4 is a table representing exemplary operation of the gateway of FIG. 3;

FIG. 5 is a ladder diagram representing exemplary messages to support roaming in accordance with one embodiment of the present invention;

FIG. 6 is a ladder diagram representing exemplary messages to support roaming in accordance with one embodiment of the present invention; and

FIG. 7 is a ladder diagram representing exemplary messages to support roaming in accordance with one embodiment of the present invention;

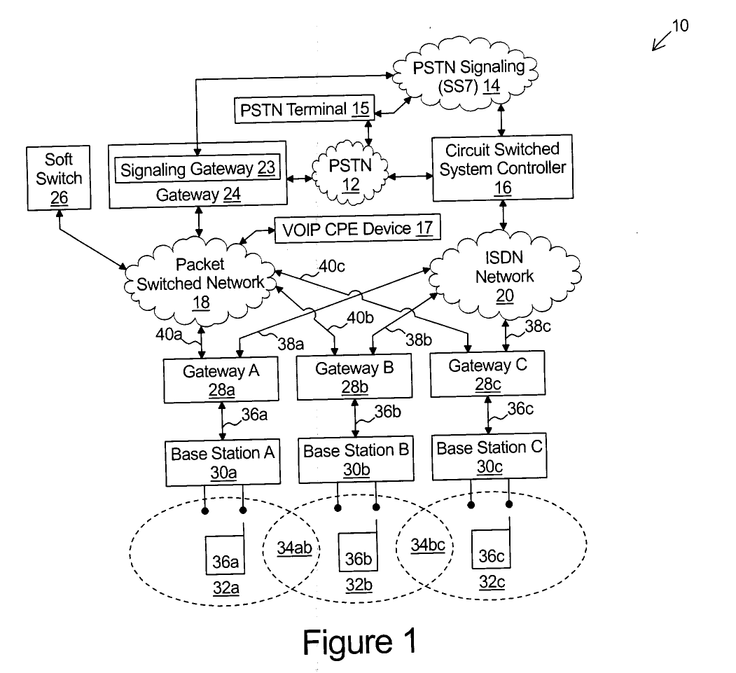

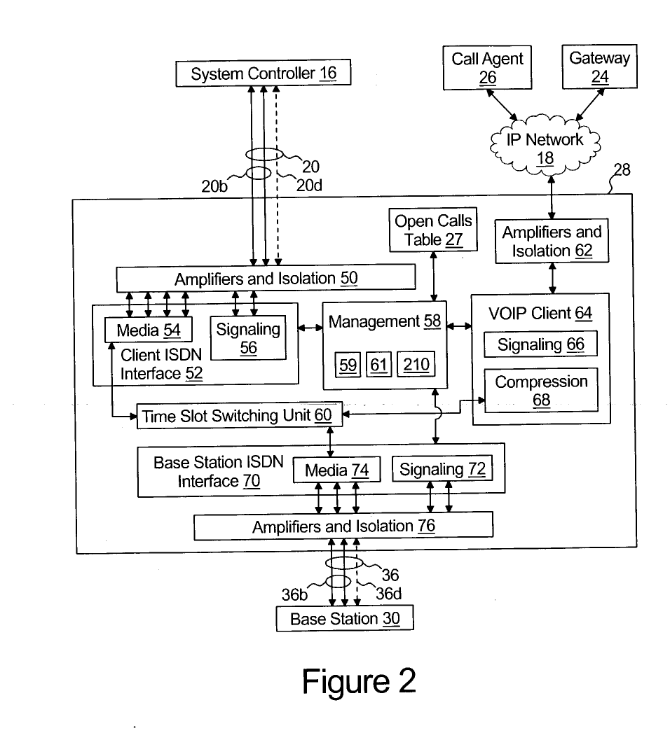

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

A hybrid circuit switched and IP based microcellular wireless telephone system 10 comprises a plurality of wireless handsets 36a-36c, a plurality of base stations 30a-30c, a plurality of gateways 28a-28c, an IP soft switch 26, a PSTN gateway 24, and a circuit switched system controller 16. In the exemplary embodiment, an ISDN circuit switched network 20 (which may be part of the public switched telephone network “PSTN”) interconnects the circuit switched system controller 16 with each of the gateways 28a-28c and with the base station 30a-30c over a dedicated (or leased) ISDN line 38a-38c respectively.

A packet switched network 18, such as a combination of a managed IP network and/or the Internet, interconnects each of the gateways 28a-28c with the IP soft switch 26, the PSTN gateway 24, and a plurality of remote VoIP CPE devices 17 such as VoIP telephone systems, remote MTAs, or VoIP gateways.

Each of the PSTN gateway 24 and the circuit switched system controller 16 are coupled to the PSTN 12 and to the PSTN signaling network (e.g. SS7 network) 14.

The circuit switched system controller 16 may be a system controller that operates as a service switching point in accordance with the Public Personal Handy-Phone System Specifications which are promulgated by the PHS MoU Group, (Association of Radio Industries and Businesses, Tokyo Japan).

Each of the base stations 30a-30c may include known structure for wirelessly communicating with each of a plurality of the handsets 36a-36c within the cell 32 supported by the base station. Exemplary structure for each of the base stations 30a-30c and the handsets 36a-36c would include known systems that operate in accordance with the Public Personal Handy-Phone System Specifications.

The soft switch 26 may be a system that provides the proxy server functions of the various Session Initiation Protocols (SIP) or the call agent functions of the Multimedia Gateway Control Protocol (MGCP) for signaling VoIP media sessions.

The PSTN gateway 24 may be a known trunking gateway for interfacing between VoIP call legs and PSTN call legs. The PSTN gateway 24 may include (or be associated with) a known signaling gateway 23 for interfacing with the PSTN signaling network 14.

Each gateway 28a-28c includes circuits which provide for both inbound call routing and outbound call routing. Inbound call routing comprises routing calls directed to a wireless telephone handset 36a-36c from either the circuit switched system controller 16 or the packet switched network 18 to the gateway's associated base station 30a-30c. Outbound call routing comprises routing calls initiated by a wireless telephone handset 36a-36c (and routed to the gateway 28a-28c by its associated base station 30a-30c) to either of the circuit switched network controller 16 over the ISDN network 20 or to the soft switch 26 over the packet switched network 18.

Routing Outgoing Calls from Handset

When a call is initiated by a wireless handset, for example wireless handset 36a which is positioned within cell 32a, the wireless handset 36a generates a session signaling message which identifies a remote endpoint (e.g. a call destination). The remote endpoint may be any of a PSTN terminal 15, a VoIP CPE device 17, or another handset, for example, handset 36b. The session signaling message is provided to the base station 30a. The base station 30a in turn provides ISDN session signaling over the ISDN connection 36a to the gateway 28a.

After ISDN session signaling is provided to the gateway 28a, the call will be routed by the gateway 28a based on the identified remote endpoint. If the identified endpoint is a PSTN terminal 15 that is local, an emergency number such as 911, or other number that can be inexpensively routed on the PSTN 12, the call will be routed to the PSTN terminal 15 through the circuit switched system controller 16.

If the identified endpoint is a PSTN terminal 15 that is long distance, international, or another number that can not be inexpensively routed on the PSTN 12, then the call will be routed over the packet switched network 18 (using the soft switch 26) to the PSTN gateway 24. The PSTN gateway 24 may be geographically local to the PSTN terminal 15 and will further route the call over the PSTN 12 to such terminal 15 as a local call.

If the identified endpoint is a VoIP CPE device 17, the call will be routed over the packet switched network 18 (using the soft switch 26) to the VoIP CPE device 17.

If the identified endpoint is another handset (e.g. destination handset 36b), the call will be routed over the packet switched network 18 (using the soft switch 26) to the gateway 28b supporting the base station 30b that operates the cell 32b in which the destination handset 36b exists.

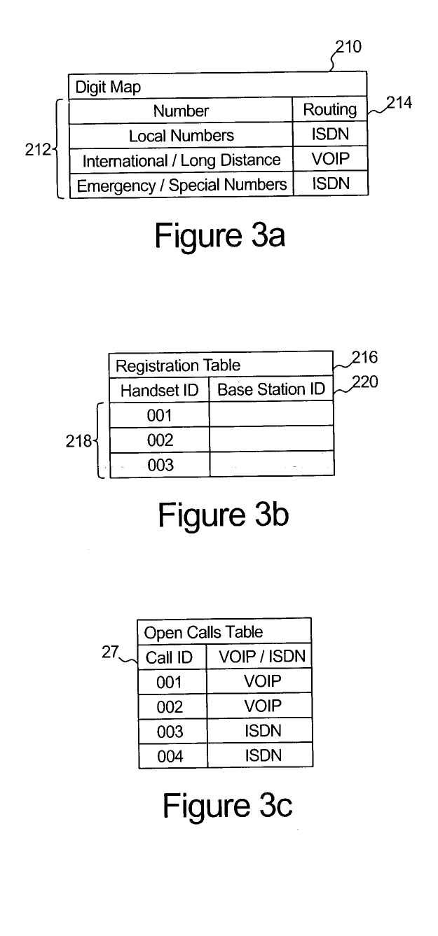

To determine how to route a call, the gateway 28a compares the identified endpoint to a digit map table 210 (as represented by FIG. 3a) to determine appropriate call routing. The digit map table 210 includes a plurality of records 212. Each record 212 associates each of a plurality of endpoints (identified by dialing numbers) to a routing 214 which is either ISDN or VoIP. ISDN routing represents routing the call through the circuit switched system controller 16 and VoIP routing represents routing the call over the packet switched network 18.

Based on the comparison of the dialed number to the digit map 210, the gateway 28a will either i) generate VoIP session signaling to the soft switch 26 over the IP network 18 (if the routing is VoIP); or ii) generate ISDN session signaling to the circuit switched system controller 16 (if the routing is PSTN).

If VoIP signaling is provided to the soft switch 26 and the identified endpoint is a PSTN terminal 15, then the soft switch 26 provides applicable VoIP session signaling to the PSTN gateway 24. The PSTN gateway 24 signals the PSTN terminal 15 utilizing the signaling gateway 23 and the PSTN signaling network 14 (e.g. the SS7 network). If the PSTN terminal 15 responds to the signaling, the PSTN gateway 24 sets up a PSTN session with the PSTN terminal 15 over the PSTN network 12. The PSTN gateway 24 also establishes a VoIP session directly with the gateway 28a and links the two sessions. The result of the above described session signaling is to set up a call comprising multiple session legs which include: i) a wireless leg between the handset 36a and the base station 30a, ii) an ISDN leg between the base station 30a and the gateway 28a, iii) a VoIP leg between the gateway 28a and the PSTN gateway 24, and iv) a PSTN leg between the PSTN gateway 24 and the PSTN terminal 15 over the PSTN 12.

If VoIP signaling is provided to the soft switch 26 and the identified endpoint is a VoIP CPE device 17, then the soft switch 26 forwards applicable VoIP session signaling to the VoIP CPE device 17. A VoIP session is established directly between the gateway 28a and the VoIP CPE device 17. The result of such session signaling is to set up a call comprising multiple session legs which include: i) a wireless leg between the handset 36a and the base station 30a, ii) an ISDN leg between the base station 30a and the gateway 28a, and iii) a VoIP leg between the gateway 28a and the VoIP CPE device 17.

If VoIP signaling is provided to the soft switch 26 and the identified endpoint is the handset 36b, then the soft switch 26 forwards applicable VoIP session signaling to the gateway 28b which supports the base station 30b which controls the cell 32b in which the handset 36b is located. A VoIP session is established directly between the gateway 28a and the gateway 28b. The gateway 28b provides ISDN session signaling to the base station 30b and the base station 30b signals the handset 36b. The result of such session signaling is to set up a call comprising multiple session legs which include: i) a wireless leg between the handset 36a and the base station 30a, ii) an ISDN leg between the base station 30a and the gateway 28a, iii) a VoIP leg between the gateway 28a and the gateway 28b, iv) an ISDN leg between the gateway 28b and the base station 30b, and v) a wireless leg between the base station 30b and the handset 36b.

If ISDN signaling is provided to the circuit switched system controller 16, the system controller 16 provides applicable PSTN signaling to the PSTN terminal 15. Again, the PSTN signaling network 14 may be utilized. The result of such session signaling is to set up a call comprising multiple session legs which include: i) a wireless leg between the handset 36a and the base station 30a, ii) an ISDN leg between the base station 30a and the gateway 28a, iii) an ISDN leg between the gateway 28a and the system controller 16, and iv) a PSTN leg between the system controller 16 and the remote terminal 15 over the PSTN 12.

It should be appreciated that the above described VoIP session signaling may utilize known VoIP session signaling and call set up techniques such as those promulgated in the Session Initiation Protocol or those promulgated in the Multimedia Gateway Control Protocol.

Routing Inbound Calls to a Handset

When a call is initiated by a PSTN terminal 15 to one of the wireless handsets, handset 36b for example, PSTN session signaling is provided over the PSTN signaling network 14 to the circuit switched system controller 16. The signaling identifies the handset 36b.

Because the handset 36b has the ability to roam amongst all of the cells 32a-32c, the circuit switched system controller 16 utilizes a registration table 216 (as represented by FIG. 3b) to identify which of the cells 32a-32c in which the handset 36b is located. More specifically, the registration table 216 includes a plurality of records 218. Each record 218 associates the ID of a handset 36 to the ID 220 of the base station 30 with which the handset 36 is then currently registered.

The circuit switched system controller 16 then provides ISDN session signaling, over the ISDN line 38b, to the gateway 28b that supports the base station 30b operating the cell 32b in which the handset 36b is then currently located. The gateway 28b provides ISDN session signaling to the base station 30b over the ISDN link 36b. And, the base station 30b provides call signaling to the handset 36b.

The result of the above described signaling is to set up a call comprising multiple session legs including: i) a PSTN leg between the remote PSTN terminal 15 and the circuit switched system controller 16; ii) an ISDN leg between the circuit switched system controller 16 and the gateway 28b, iii) an ISDN leg between the gateway 28b and the base station 30b, and iv) a wireless leg between the base station 30b and the handset 36b.

Roaming

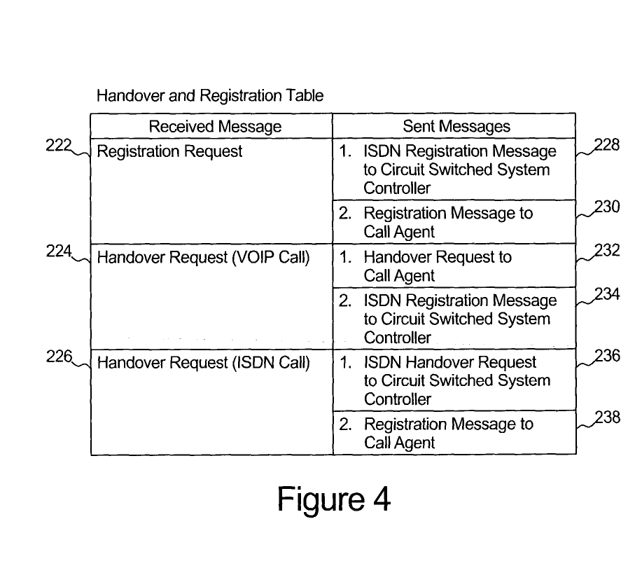

Each of the base stations 30a-30c support those of handsets 36a-36c that are within a geographic cell 32a-32c supported by the base station. More specifically, each base station 30a-30c supports those handsets which are registered with the base station. Each base station 30a-30c supports roaming of each handset 36a-36b and hand-off of an in-process call when a handset, for example handset 32b, roams from, for example, cell 30b into cell 30c. Roaming may take place when there is no call in progress or when a call is in progress. The table of FIG. 4 provides an overview of registration and handover messaging for enabling roaming.

If there is not a call in progress, roaming is accomplished within system 10 as follows. When the handset 36b detects adequate signal strength to communicate with base station 32c, the handset 36b will make a registration request to the base station 30c. The base station 32c will then pass a registration request to the gateway 28c. The registration request is represented by 222 in FIG. 4. In response to receiving the single registration request 222, the gateway 28c will generate two registration requests 228 and 230. The gateway 28c will send the first registration request 228 to the circuit switched system controller 16. In response, the circuit switched system controller will authenticate the handset 36b, update its registration table to reflect the new location of the handset 36b, and acknowledge the registration back to the gateway 28c. The gateway 28c will send the second registration request 230 to the soft switch 26. In response, the soft switch 26 will authenticate the handset 36b, update its registration table to reflect the new location of the handset 36b, and acknowledge the registration back to the gateway 28c.

If there is a call in progress, roaming is accomplished within system 10 as follows. When the handset 36b detects adequate signal strength to communicate with base station 32c, the handset 36b will make a single hand-over request to base station 30c. The hand-over request includes a session ID number uniquely associated with the in progress call. The base station 32c will then send a hand-over request to the gateway 28c. The gateway 28c will determine whether the call is routed through the circuit switched network controller 16 (e.g. a PSTN call) or a call routed over the packet switched network 18 (e.g. a VoIP call).

If the hand over request identifies a VoIP call as represented by 224, the gateway 28c will generate a hand-over request 232 to the soft switch 26. In response, the soft switch 26 will authenticate the handset 36b, update its registration table to reflect the new location of the handset 36b, provide a VoIP session replace message to the other VoIP device (e.g the PSTN gateway 24, the VoIP CPE device 17, or another gateway 28) so that a new VoIP call leg can be established between such VoIP device and the gateway 28c, and acknowledge the registration back to the gateway 28c. The gateway 28c will also send a registration request 234 to the circuit switched network controller 16. In response, the circuit switched network controller 16 will authenticate the handset 36b, update its registration table to reflect the new location of the handset 36b, and acknowledge the registration back to the gateway 28c. This methodology enables the hand-over to take place and provides for the circuit switched network controller 16 to update its registration table.

If the hand over request identifies a PSTN call as represented by 226, the gateway 28c will generate a hand-over request 236 to the circuit switched system controller 16. In response, the circuit switched system controller 16 will authenticate the handset 36b, update its registration table to reflect the new location of the handset 36b, set up an ISDN call leg with the gateway 28c for supporting the in-progress call, and acknowledge the registration back to the gateway 28c. The gateway 28c will also send a registration request 238 to the soft switch 26. In response, the soft switch 26 will authenticate the handset 36b, update its registration table to reflect the new location of the handset 36b, and acknowledge the registration back to the gateway 28c. This methodology enables the hand-over to take place and provides for the soft switch 26 to update its registration table.

Gateway

Referring briefly to FIG. 3, each gateway 28 comprises: i) a client interface 52 for communicating with the system controller 16 over the dedicated ISDN line 20, ii) a base station ISDN interface 70 for communicating with the base station 30 over the ISDN line 36, iii) a VoIP interface 64 for communicating over the IP network 18 with any of the soft switch 26, the PSTN gateway 24, the VoIP CPE device 17 and another gateway 28, iv) a management module 58, and v) a time slot switching unit 60 interconnecting each of the client interface 52, the base station ISDN interface 70, and the VoIP interface 64.

The client interface 52 is a known in the art ISDN integrated circuit (e.g. chip set and appropriate operating drivers) that includes a media module 54 for generating ISDN digital media communication signals on a media channel 20b and a signaling module 56 for generating ISDN compliant messages on a data channels 20d of the ISDN line 20. The client interface 52 operates as a client ISDN device to the system controller 16. A block of amplifiers and isolation circuits 50 couple between the first IDSN interface 52 and the IDSN line 20.

The base station ISDN interface 70 is also a known in the art ISDN integrated circuit (e.g. chip set and appropriate operating drivers) that includes a media module 74 for generating ISDN digital media communication signals on a media channel 36b and a signaling module 72 for generating ISDN compliant messages on a data channel 36d of the ISDN line 36. The base station ISDN interface 70 emulates the ISDN functions of the system controller 16 when interfacing with the base station 30. A block of amplifiers and isolation circuits 76 couple between the base station IDSN interface 70 and the ISDN line 36.

The VoIP interface 64 comprises a signaling translation module 66 and a compression-decompression module 68 which, in combination, convert between: i) call signaling messages and digital audio media exchanged with the base station ISDN interface 70 and ii) VoIP signaling and compressed audio media exchanged over the IP network 18 with any of the soft switch 26, the PSTN gateway 24, the VoIP CPE device 17, and other gateways 28.

The signaling translation module 66 converts between call signaling messages exchanged with the base station ISDN interface 70 and VoIP call signaling messages exchanged over the network 18.

The compression-decompression module 68 operates algorithms which convert between the digital audio media exchanged with the base station ISDN interface 70 and the compressed digital audio that may be transmitted over a the network 18 as part of a VoIP call leg. Exemplary compression-decompression algorithms utilized by the compression-decompression module 68 include: i) very high compression algorithms such as algorithms commonly referred to as G.723.1 and G.729D; and ii) algorithms that provide compression and high audio quality such as algorithms commonly referred to as G.728, and G.729E.

The time division multiplex bus (TDM bus) 60 interconnects between the media module 54 of the client interface 52, the media module 74 of the base station ISDN interface 70 and the compression module 68. The time slot switching unit 60 supports the transfer of digital media data between such components on separate time division channels to support the media session of a call through the gateway 28. The time slot switching unit 60 may be a synchronous full duplex communication line supporting frame transfer of media data and control data. An exemplary time slot switching unit 60 may be a four wire serial interface bus operating in accordance with a standard known as IOM-2 which has been developed to support media, control and programming, and status channel communications between telecommunication integrated circuits.

The management module 58 control operation of the gateway 28 and enables the routing of inbound and outbound calls and the roaming functionality discussed above. The management module may comprise the digit map table 210, a call identification module 59, and a roaming messaging module 61.

The digit map table 210 operates as previously discussed with reference to FIG. 3a.

The call identification module 59 may manage or comprise the open calls table 27 as previously discussed with FIG. 3c. Alternatively, the call identification module 59 may comprises appropriate code for making an inquiry over the packet switched network 18 to a remote open calls table 27 which in turn provides a response indicating whether an in process call is an ISDN call supported by the circuit switched network controller 16 or is a VoIP call.

The roaming message module provides the messaging discussed with respect to FIG. 4 to support roaming of a wireless telephone handset 36. The following discussion of messaging within system 10 to support roaming and hand over provides further description of operation of the management module 58.

Roaming-No Call in Progress

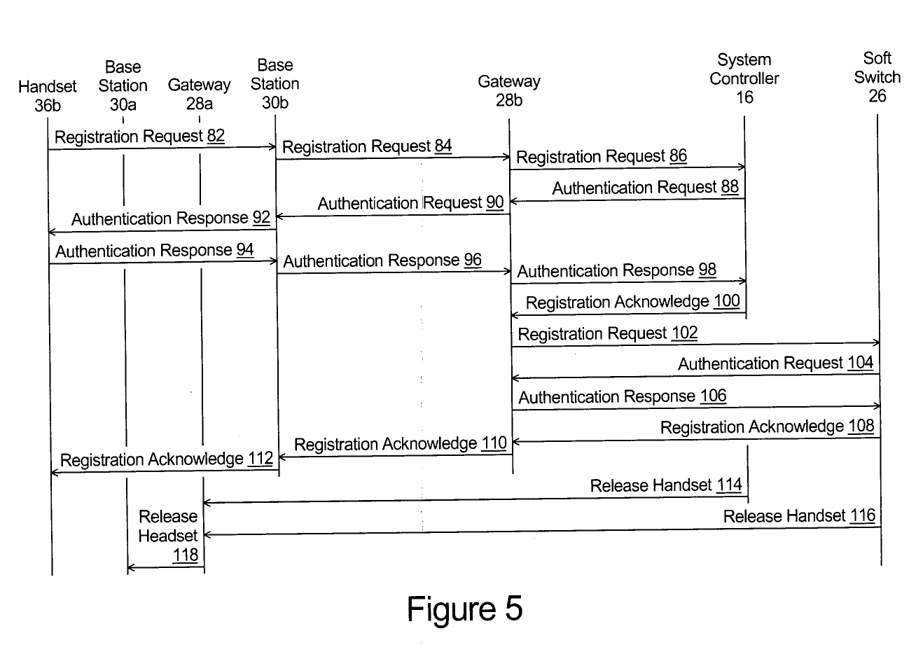

FIG. 5, is a ladder diagram representing registration messaging for handset 36b roaming from cell 32a (supported by base station 30a) to cell 32b (supported by base station 30b) when no call is in progress.

Step 82 represents the base station 30b receiving a registration request message from the handset 36b when the handset 36b roams into the cell 32b. The registration request message identifies the handset 36b.

Step 84 represent the base station 30b sending, and the gateway 28b receiving from the base station 30b, a registration request message in response to the base station 30b receiving the registration request message from the handset 36b at step 82.

As discussed, the gateway 28b is responsible for assuring that the registration is provided to both the circuit switched system controller 16, and the soft switch 26. Steps 86-100 represent the gateway 28b registering the handset 36b with the system controller 16 and steps 108-108 represent the gateway 28b registering the handset 36b with the soft switch 26. Although the ladder diagram of FIG. 5 shows registration first with the system controller 16 and secondly with the soft switch 26, it should be appreciated that messaging time may be such that the two registrations are occurring simultaneously.

Step 86 represents the gateway 28b sending a registration request message to the system controller 16. The registration request message sent at step 86 has the same format and data content as the registration request message send at step 84.

Step 88 represents the gateway 28b receiving an authentication request from the system controller 16. The authentication request will include a random number generated by the system controller 16. The gateway 28b will capture the random number from the authentication request.

Step 90 represents the gateway 28b sending, and the base station 30b receiving from the gateway 28b, an authentication request in response to the gateway 28b receiving the authentication request of step 88. The authentication request of this step 90 is of the same format and the same data content as the authentication request of step 88.

Step 92 represents the base station 30b sending an authentication request message to the handset 36b.

Step 94 represents the base station 30b receiving an authentication response message from the handset 36b. The authentication response will include the result of a calculation performed on the random number that is unique to the handset 36b. An exemplary calculation would include those specified in the PHS system specifications.

Step 96 represent the base station 30b sending, and the gateway 28b receiving from the base station 30b, an authentication response message in response to the base station 30b receiving the authentication response message from the handset 36b at step 94. The authentication response received by the gateway 28b includes the result of the calculation preformed by the handset 36b.

Step 98 represents the gateway 28b sending an authentication response message to the system controller 16. The authentication response message sent at step 86 has the same format and data content as the authentication response message send at step 96. The gateway captures the result of the calculation from the authentication response message. Both the random number captured from the authentication request and the result of the calculation from the authentication response message are stored by the management module 58.

Step 100 represents the gateway 28b receiving a registration acknowledge message from the system controller 16 which acknowledges successful registration of the handset 36b by the system controller 16.

Step 102 represents the gateway 28b sending a registration request message to the soft switch 26 over the network 18. The registration request message identifies the handset 26b.

Step 104 represents the gateway 28b receiving an authentication request from the soft switch 26. The authentication request may be a request for both the random number generated by the circuit switched system controller 16 and the result of the calculation performed by the handset 36b.

Step 106 represents the gateway 28b sending an authentication response message to the soft switch 26. The authentication response message sent at step 106 may include both the random number and the result of the calculation.

In an alternative embodiment, the authentication request may include a random number generated by the soft switch 26. In this alternative embodiment, the management module 58 utilizes a combination of: i) the random number generated by the circuit switched system controller; ii) the result of the calculation generated by the handset 36b; and iii) other handset data captured during the exchange or registration messages to replicate the calculation algorithm utilized by the handset. The management module 58 then utilizes the replicated calculation algorithm to perform a calculation on the random number generated by the soft switch 26. In this alternative embodiment, the authentication response includes the result of the calculation performed by the management module 58 on the random number generated by the soft switch 26.

Step 108 represents the gateway 28b receiving a registration acknowledge message from the soft switch 26 which acknowledges successful registration of the handset 36b by the soft switch 26.

After the gateway 28b has received successful registration acknowledge messages from both the system controller 16 (at step 100) and the soft switch 26 (at step 108), then gateway 28b provides a registration acknowledge message to the base station 30b at step 110.

At step 112, the base station 30b provides a registration acknowledge message to the handset 36b.

Step 114 represents the system controller 16 providing, and the gateway 28a (e.g the original gateway with which the handset 36b was registered prior to completion of the steps 82 through 112) receiving from the system controller 16, a release handset message to the original gateway which the handset 36b was registered prior to roaming.

Step 116 represents the soft switch 26 providing, and the gateway 28a receiving from the soft switch 26, a release handset message.

After the original gateway 28a has received release handset messages from both the system controller 16 and the soft switch 26, then the original gateway 28a will provide a release handset message to the original base station 30a at step 118. The release handset message at step 118 has the same format and data content as the release handset message provided by the system controller 16 at step 114.

Roaming-PSTN Call in Progress

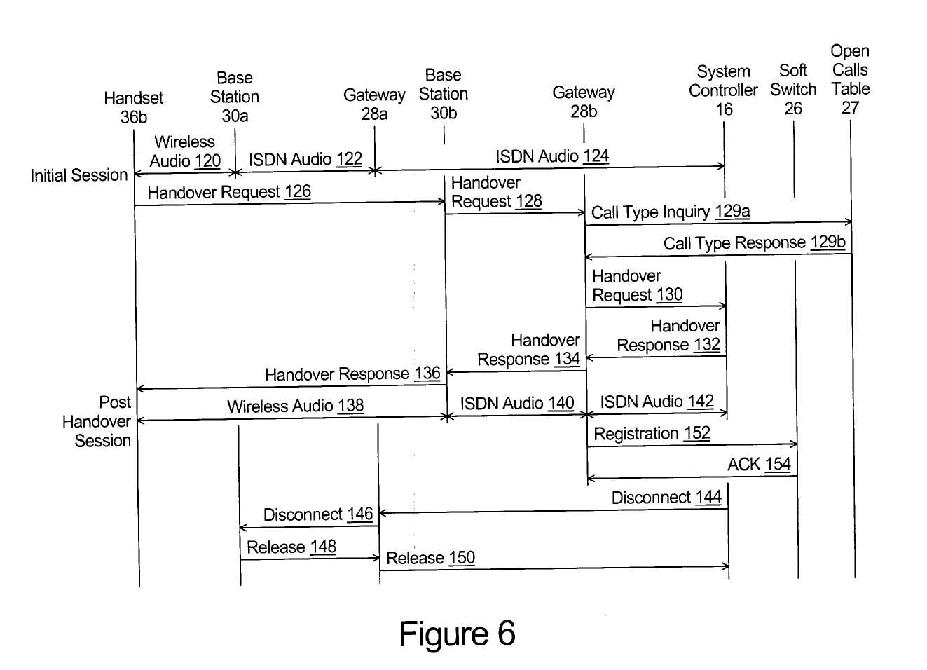

Referring to FIG. 6, is a ladder diagram representing a handset, handset 36b for example, roaming during an ongoing PSTN media session (e.g. a call routed through the system controller 16), from cell 32a into the cell 32b which are supported by base stations 30a and 30b respectively.

Steps 120, 122, and 124 represent the exchange of digital audio during the ongoing media session. More specifically, step 120 represents the exchange of digital audio data over a wireless channel between the handset 36a and the base station 30a, step 122 represents the exchange of digital audio data over an ISDN media channel between the base station 30a and the gateway 28a, and step 124 represents the exchange of digital audio data over an ISDN media channel between the gateway 28a and the system controller 16.

Step 126 represents the base station 30b receiving a handover request message from the handset 36b when the handset 36b roams into the cell 32b. The handover message includes identification of the handset 26b as well as a call identifier.

Step 128 represents the base station 30b sending, and the gateway 28b receiving from the base station 30b, a handover request message in response to the base station 30b receiving the handover request message from the handset 36b at step 82.

At this point, the handover request includes a call identifier, but there is no information in the handover request to identify whether the call is a VoIP call (routed over network 18) or a PSTN call (routed through the system controller 16. Steps 129a and 129b represent the call identification module 59 either: i) inquiring and receiving a response from its own open calls table 27 identifying whether the in process call is a VoIP call or an ISDN call; or ii) inquiring and receiving a response from a remote open calls table 27 over the network 18 identifying whether the in process call is a VoIP call or an ISDN call.

The soft switch 26 may maintain the open calls table 27. In which case the inquiry to the remote open calls table 27 may be an inquiry to the soft switch 26. If the call identification module 59 maintains a local open calls table 27, then it should be appreciated that it must periodically update such table 27 to reflect the status of all calls maintained within the system 10.

As previously discussed with respect to FIG. 4, the gateway 28b is responsible for assuring handover is performed with the system controller (for a PSTN call) and simultaneously assuring that registration is performed with the soft switch 26. Steps 130-150 represent the gateway 28b performing handover with the system controller 16 and steps 152 and 154 represent the gateway 28b registering the handset 36b with the soft switch 26. Although the ladder diagram of FIG. 6 shows handover with the system controller 16 first and registration with the soft switch 26 second, it should be appreciated that messaging time may be such that both are occurring simultaneously.

Step 130 represents the gateway 28b sending a handover request message to the system controller 16. The handover request message sent at step 130 has the same format and data content as the handover request message send at step 128.

Step 132 represents the gateway 28b receiving a handover response from the system controller 16. It should be appreciated that between steps 132 and steps 134, various authentication messages similar to those discusses with reference to steps 88-98 of FIG. 5 may be performed.

Step 134 represents the gateway 28b sending, and the base station 30b receiving from the gateway 28b, a handover response in response to the gateway 28b receiving the handover response of step 132. The handover response of this step 134 is of the same format and the same data content as the handover response of step 132.

Step 136 represents the base station 30b sending a handover response message to the handset 36b.

Steps 138, 140, and 142 the exchange of digital audio during the ongoing media session following completion of the handover. More specifically, step 138 represents the exchange of digital audio data over a wireless channel between the handset 36b and the base station 30b, step 140 represents the exchange of digital audio data over an ISDN media channel between the base station 30b and the gateway 28b, and step 144 represents the exchange of digital audio data over an ISDN media channel between the gateway 28b and the system controller 16.

Because the gateway 28b remains responsible for assuring that the location of the handset 36b is properly entered in applicable tables of the soft switch 26, steps 152 and 154 represents registration with the soft switch 26 and therefore represent similar functionality to that discusses with respect to steps 102-108 of FIG. 5.

Step 144 represents the original gateway 28a receiving a disconnect message from the system controller 16. The disconnect message is sent to the original gateway 28a upon completion of handover and the call being transferred to operate through the new gateway 28b. Step 146 represents the gateway 28a sending, and the base station 30a receiving from the gateway 28a, a disconnect message in response to the gateway 28a receiving the disconnect message at step 144.

In response to receiving the disconnect message at step 146, the base station 30a acknowledges by sending to the gateway 28a a release message as represented by step 148. In response to receiving the release message at step 148, the gateway 28a sends a release message 150 to the system controller as represented by step 150.

Roaming VoIP Call in Progress.

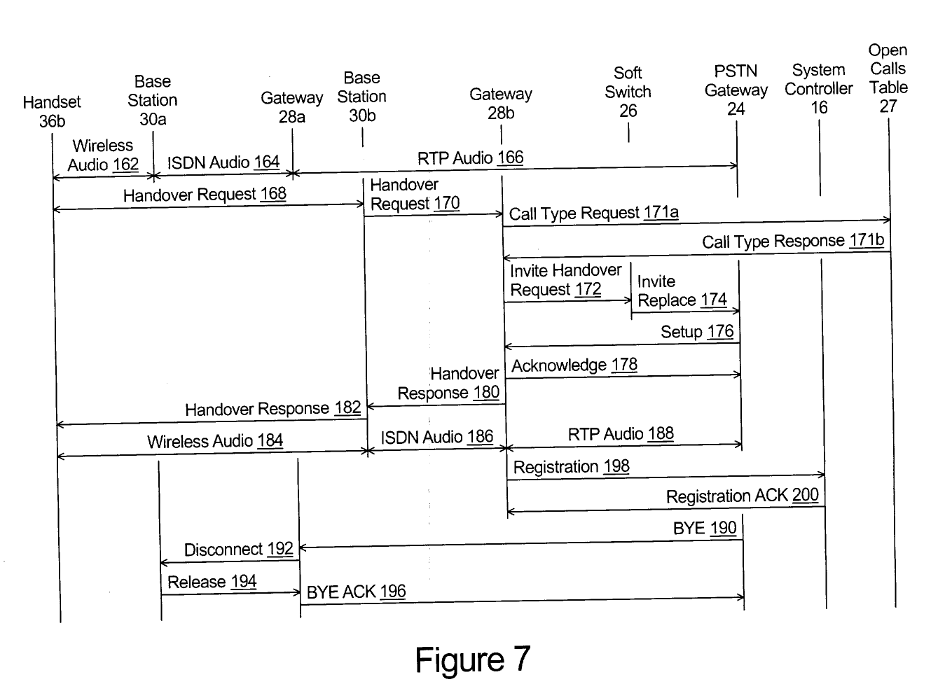

FIG. 7, is a ladder diagram representing a handset, handset 36b for example, roaming during an ongoing VoIP media session (for example, a VoIP call session routed through the gateway 24), from cell 32a into the cell 32b which are supported by base stations 30a and 30b respectively.

Steps 162, 164, and 166 represent the exchange of digital audio during the ongoing media session. More specifically, step 162 represents the exchange of digital audio data over a wireless channel between the handset 36b and the base station 30a, step 164 represents the exchange of digital audio data over an ISDN media channel between the base station 30a and the gateway 28a, and step 166 represents the exchange of digital audio data over a VoIP media session between the gateway 28a and the PSTN gateway 24.

Step 168 represents the base station 30b receiving a handover request message from the handset 36b when the handset 36b roams into the cell 32b. The hand over request is of the same message format and data content as the hand over request discussed above with respect to step 126 of FIG. 6.

Step 170 represent the base station 30b sending, and the gateway 28b receiving from the base station 30b, a handover request message in response to the base station 30b receiving the handover request message from the handset 36b at step 168.

At this point, the handover request includes a call identifier, but there is no information in the handover request to identify whether the call is a VoIP call (routed over network 18) or a PSTN call (routed through the system controller 16). Steps 171a and 171b includes steps similar to those discussed with respect to steps 129a and 129b of FIG. 6.

Step 172 represents the gateway 28b sending an invite handover request message to the soft switch 26. The invite handover request message includes the call identifier and include an IP address and port number established by the gateway 28b for the call.

Step 174 represents the soft switch 26 sending an invite replace message 174 to the PSTN gateway 24. The invite replace message identifies the call to replace and includes the internet address and port number of gateway 28b as established by the gateway 28b for set up of the call.

Step 176 represents the PSTN gateway 24 responding to the invite replace message by sending a set up message to the gateway 28b. The set up message includes the IP address and port number established by the PSTN gateway 24 for the call.

Step 178 represents the gateway 28b providing an acknowledgement message back to the PSTN gateway 24 in response to receiving the set up message of step 176. The combination of the set up and acknowledgment messages at steps 176 and 178 may include various other messages for negotiating compression capabilities and other session parameters needed to establish a VoIP between the gateway 28b and the gateway 24.

After the VoIP session is established between the gateway 28b and the PSTN gateway 24, step 180 represents the gateway 28b sending, and the base station 30b receiving from the gateway 28b, a handover response. The handover response of this step 180 is of the same format and data content as the handover response of step 132 discussed above with respect to FIG. 6.

Step 182 represents the base station 30b sending a handover response message to the handset 36a. The hand over response of this step 182 is of the same format and data content as handover response of step 136 discussed above with respect of FIG. 6.

Steps 184, 186, and 188 represent the exchange of digital audio during the ongoing media session following completion of the handover. More specifically, step 184 represents the exchange of digital audio data over a wireless channel between the handset 36b and the base station 30b, step 186 represents the exchange of digital audio data over an ISDN media channel between the base station 30b and the gateway 28b, and step 188 represents the exchange of digital audio data over a VoIP media session between the gateway 28b and the PSTN gateway 24.

The base station 30b remains responsible for assuring that the location of the handset 36a is properly entered in applicable tables of the system controller 16. Therefore, steps 198 and 200 represents the base station 30b registering the handset 26b with the system controller 16 utilizing the process discussed with respect to steps 86-100 of FIG. 5.

Step 190 represents the PSTN gateway 24 sending, and original gateway 28a receiving, a bye or disconnect message.

Step 192 represents the gateway 28a sending, and the base station 30a receiving form the gateway 28a, a disconnect message in response to the gateway 28a receiving the bye message at step 190. The disconnect message of this step 192 is of the same format and data content as the disconnect message of step 146 discussed above with respect to FIG. 6.

In response to receiving the disconnect message at step 192, the base station 30a acknowledges by sending to the gateway 28a a release message as represented by step 194. The release message of step 194 is of the same message format and data content as the release message of step 148 discussed above with respect to FIG. 6.

Step 196 represents the gateway 28a responding to the bye message of step 190 by sending a bye-acknowledgement message to the PSTN gateway 24.

In summary, the system of the present invention enable roaming in a cellular system wherein calls may be completed either using a circuit switched network and system controller or a packet switched network. Each gateway provides for routing of calls to either the circuit switched system controller or over the packet switched network. Each gateway also supports roaming of handsets by determining which type of call is in progress and performing the applicable hand over of the call. The gateway also registers the location of the handset with the system controller and a soft switch that is not part of the call handover.

It should be appreciated that the systems and methods discussed herein provide for more accurate detection of communication session details than known systems. In particular, the system and methods provide for more accurate determination of a communication session termination time than known systems.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A IP telephony gateway for operation with a base station of a hybrid micro cellular wireless telephone network, the base station supporting roaming of a wireless telephone into a cell controlled by the base station, the IP telephony gateway comprising:
a circuit switched network interface for exchanging system messaging, call signaling, and audio media with a circuit switched system controller over a circuit switched network;
a base station network interface for exchanging system messaging, call signaling, and audio media with a base station;
a VoIP client for exchanging system messaging, call signaling and audio media with a remote VoIP device over a packet switched network;
a time slot switching unit interconnecting, and transferring audio media between the base station network interface and each of:
i) the circuit switched network interface for supporting a media session with the circuit switched system controller; and
ii) the VoIP client for supporting a VoIP media session over the packet switched network;
a management module for interfacing messages exchanged with the base station, over the base station network interface, with each of the circuit switched system controller and the soft switch to support roaming of the wireless telephone into the cell controlled by the base station.

2. The IP telephony gateway of claim 1, wherein the management module includes a roaming messaging module that provides for generating both:
i) a first registration message to the circuit switched system controller, and
ii) a second registration message to the soft switch, in response to receiving a single registration message initiated by the wireless telephone roaming into the cell controlled by the base station.

3. The IP telephony gateway of claim 2, wherein the roaming messaging module further provides for:
generating both: i) a handover message to the circuit switched system controller, and ii) a registration message to the soft switch, in response to receiving a single handover message initiated by the wireless telephone roaming into the cell controlled by the base station and wherein the handover message includes a call identifier associated with a call routed through the circuit switched system controller; and
generating both: i) a handover message to the soft switch, and ii) a registration message to the circuit switched system controller, in response to receiving a single handover message initiated by the wireless telephone roaming into the cell controlled by the base station and wherein the handover message includes a call identifier associated with a call routed over the packet switched network.

4. The IP telephony gateway of claim 3, wherein the roaming messaging module comprises a mapping table that associates each message that the gateway may receive to a plurality of messages that the gateway generates in response thereto.

5. The IP telephony gateway of claim 3, wherein the management module establishes a circuit switched connection with the circuit switched system controller in response to receiving a hand over acknowledgement from the circuit switched system controller that includes the call identifier.

6. The IP telephony gateway of claim 5, wherein the handover message to the soft switch includes identification of a gateway port configured for signaling a VoIP media session.

7. The IP telephony gateway of claim 6, wherein the management module further establishes a VoIP channel with a remote VoIP device in response to receiving a VoIP session set up request from the remote VoIP device on the gateway port.

8. The IP telephony gateway of claim 3, wherein the management module further includes a call identification module for determining which of the circuit switched system controller and the packet switched network is supporting an in process call associated with the call identifier.

9. The IP telephony gateway of claim 8, wherein the call identification module maintains an in process calls table that associates each call identifier with an indication of which of the circuit switched system controller and the packet switched network is supporting an in process call associated with the call identifier.

10. The IP telephony gateway of claim 8, wherein the call identification module couples to a remote in process calls table which associates each call identifier with an indication of which of the circuit switched system controller and the packet switched network is supporting an in process call associated with the call identifier.

11. A method of supporting roaming of a wireless telephone into a cell controlled by a base station in a hybrid micro cellular wireless telephone network that includes a gateway coupled to the base station and supporting both circuit switched media sessions with a system controller and VoIP media sessions over a packet switched network, the method comprising generating both: i) a first registration message to the circuit switched system controller, and ii) a second registration message to a soft switch, in response to receiving a single registration message initiated by the wireless telephone roaming into the cell controlled by the base station.

12. The method of claim 11, further comprising:
generating both: i) a handover message to the circuit switched system controller, and ii) a registration message to the soft switch, in response to receiving a single handover message initiated by the wireless telephone roaming into the cell controlled by the base station and wherein the handover message includes a call identifier associated with a call routed through the circuit switched system controller; and
generating both: i) a handover message to the soft switch, and ii) a registration message to the circuit switched system controller, in response to receiving a single handover message initiated by the wireless telephone roaming into the cell controlled by the base station and wherein the handover message includes a call identifier associated with a call routed over the packet switched network.

13. The method of claim 12, further comprising:
establishing a circuit switched connection with the circuit switched system controller in response to receiving a hand over acknowledgement from the circuit switched system controller that includes the call identifier.

14. The method of claim 13, wherein the handover message to the soft switch includes identification of a gateway port configured for signaling a VoIP media session.

15. The method of claim 14, wherein the management module further establishes a VoIP channel with a remote VoIP device in response to receiving a VoIP session set up request from the remote VoIP device on the gateway port.

16. The method of claim 12, further comprising:
determining which of the circuit switched system controller and the packet switched network is supporting an in process call associated with the call identifier.

17. The method of claim 16, further comprising maintaining an in process calls table that associates each call identifier with an indication of which of the circuit switched system controller and the packet switched network is supporting an in process call associated with the call identifier.

18. The method of claim 16, further comprising:
making an inquiry to a remote in process calls table; and
receiving a response from the remote in process calls server identifying which of the circuit switched system controller and the packet switched network is supporting an in process call associated with the call identifier.
